(19) United States
(12) Patent Application Publication
(10) Pub. No.: US 2022/0283758 A1
(43) Pub. Date: Sep. 8, 2022

(54) IMAGE FORMING APPARATUS, NON-TRANSITORY COMPUTER READABLE MEDIUM, AND IMAGE FORMING METHOD

(71) Applicant: FUJIFILM Business Innovation Corp., Tokyo (JP)

(72) Inventor: Takahiro TOJO, Kanagawa (JP)

(73) Assignee: FUJIFILM Business Innovation Corp., Tokyo (JP)

(21) Appl. No.: 17/378,837

(22) Filed: Jul. 19, 2021

(30) Foreign Application Priority Data
Mar. 2, 2021 (JP) 2021-032563

(51) Int. Cl. G06F 3/12; G06F 21/60

(52) U.S. Cl. CPC G06F 3/1238; G06F 3/1222; G06F 3/1267; G06F 21/608

(57) ABSTRACT

An image forming apparatus includes: a processor configured to: acquire a password registered in an image forming apparatus of plural image forming apparatuses connected to a network; and when a password that has been set in a print job and is required to output the print job matches the registered password, allow outputting of the print job.

### CROSS-REFERENCE TO RELATED APPLICATIONS

This application is based on and claims priority under 35 USC 119 from Japanese Patent Application No. 2021-032563 filed Mar. 2, 2021.

### BACKGROUND

### (i) Technical Field

The present disclosure relates to an image forming apparatus, a non-transitory computer readable medium, and image forming method.

### (ii) Related Art

JP-A-2007-083439 discloses a printing apparatus capable of printing a password-protected electronic document. The printing apparatus includes a unit that presets at least one password in the printing apparatus as an input unit of the password, a unit that verifies the password preset in the printing apparatus when the password-protected electronic document is received, and a unit that performs printing when the verification shows that there is a matching password.

JP-A-2018-18318 discloses an image forming apparatus. The image forming apparatus set as a slave unit is applied to a printing system including a user terminal and multiple image forming apparatuses which are connected to a network. A print service is available on the print system. In the print service, the user terminal transmits a print job to a master unit based on identification information of an image forming apparatus set as the master unit among the multiple image forming apparatuses, the master unit stores the print job from the user terminal, the image forming apparatus set as the slave unit, among the multiple image forming apparatuses, executes the print job stored in the master unit. The image forming apparatus includes an identification information setting storage that stores the identification information of the master unit, and an identification information transmission controller that transmits the identification information stored in the identification information setting storage to the user terminal when the print service is used.

### SUMMARY

An image forming apparatus has been proposed that stores a password in advance in order to output a print job for which a password has been set, which allows a user to omit input of the password in outputting the print job or to omit an output instruction after unlock the password.

However, when multiple image forming apparatuses are connected to a network, it is necessary for the user to input or unlock a password in outputting the print job with an image forming apparatus other than the image forming apparatus in which the password is registered, which takes time and effort for a user.

Aspects of non-limiting embodiments of the present disclosure relate to an image forming apparatus, a non-transitory computer readable medium, and an image forming method that, when multiple image forming apparatuses have a predetermined relationship, can output a print job for which a password has been set even using an image forming apparatus in which a password has not been registered in advance without requiring a user to input a password.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a processor configured to: acquire a password registered in an image forming apparatus of plural image forming apparatuses connected to a network; and when a password that has been set in a print job and is required to output the print job matches the registered password, allow outputting of the print job.

### BRIEF DESCRIPTION OF THE DRAWINGS

Exemplary embodiment(s) of the present disclosure will be described in detail based on the following figures, wherein:

FIG. 1 is a schematic configuration diagram showing an image forming system according to an exemplary embodiment of the present disclosure;

FIG. 2 is a schematic block diagram of the image forming apparatus according to the exemplary embodiment of the present disclosure;

FIG. 3 is a sequence diagram showing an example of an operation of the image forming system according to the exemplary embodiment of the present disclosure;

FIG. 4 is a flowchart of an example of the operation of the image forming apparatus according to the exemplary embodiment of the present disclosure; and

FIG. 5 is a flowchart of the example of the operation of the image forming apparatus following FIG. 4.

### DETAILED DESCRIPTION

### Exemplary Embodiment

Hereinafter, an example of an exemplary embodiment of the present disclosure will be described with reference to the accompanying drawings. The same reference signs are given to the same or equivalent elements and parts in each drawing. Dimensional ratios in the drawings are exaggerated for convenience of description and may differ from the actual ratios.

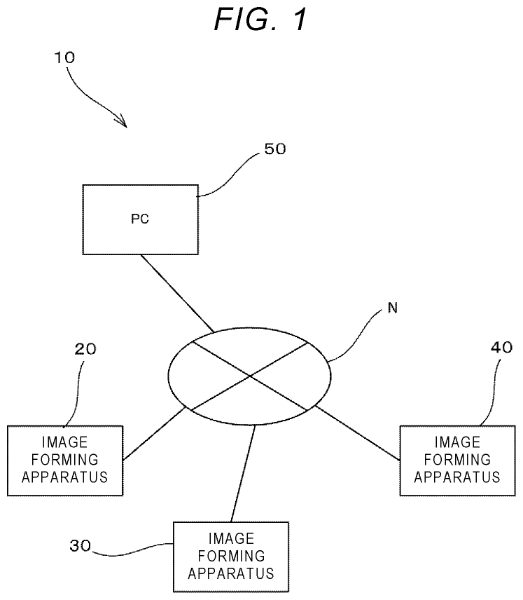

An example of an image forming system 10 according to the present exemplary embodiment will be described with reference to FIG. 1.

FIG. 1 is a diagram showing an example of a schematic configuration of the image forming system 10 according to the present exemplary embodiment.

As shown in FIG. 1, in the image forming system 10 according to the present exemplary embodiment, multiple image forming apparatuses 20, 30, and 40 are connected to each other via a network N. For example, a local area network (LAN), a wide area network (WAN), the Internet, or the like are applied to the network N. A personal computer (PC) 50 is connected to the image forming system 10 via the network N. Here, FIG. 1 shows an example in which one PC 50 is used. It is noted that the present disclosure is not limited thereto. Multiple PCs may be connected to the network N.

The multiple image forming apparatuses 20, 30, and 40 have various functions such as a printing function, a copying function, a facsimile function, and a scanner function.

Here, in the present exemplary embodiment, the multiple image forming apparatuses 20, 30, and 40 have a predetermined relationship. Specifically, the predetermined relationship refers to that, for example, one of the multiple image forming apparatuses 20, 30 and 40 (in the present exemplary embodiment, the image forming apparatus 20) is a master unit, and the remaining image forming apparatuses 30 and 40 are set as slave units. The master unit is, for example, an image forming apparatus that stores a print job and/or a password in using the printing function. It is noted that the present exemplary embodiment is not limited to the case in which the print job and the password are stored in the master unit. Alternatively, the print job and the password may be stored in the slave units or may be stored in any of the image forming apparatuses. An image forming apparatus common to all users may be set as a master unit. Alternatively, different image forming apparatuses may be set as master units for respective users.

Next, hardware configurations of the multiple image forming apparatuses 20, 30, and 40 will be described. Since the hardware configurations of the multiple image forming apparatuses 20, 30, and 40 are at least partially common, a common portion will be described by taking the image forming apparatus 30 as an example.

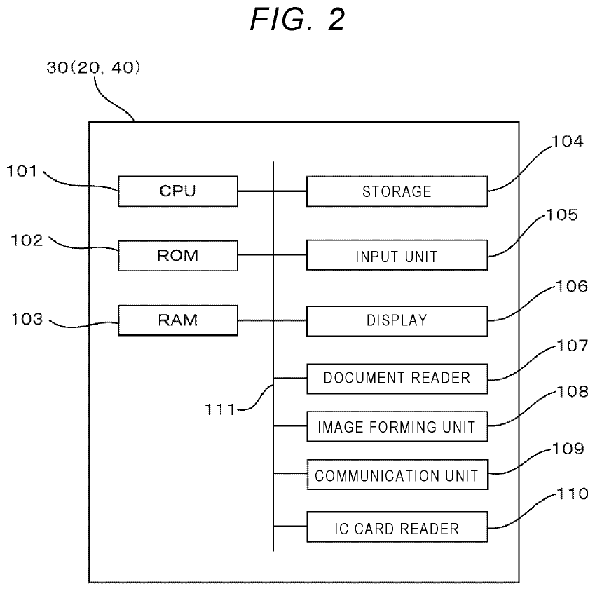

FIG. 2 is a block diagram showing the hardware configuration of the image forming apparatus 30 according to the present exemplary embodiment.

As shown in FIG. 2, the image forming apparatus 30 includes a central processing unit (CPU) 101 that is an example of a processor, a read only memory (ROM) 102, a random access memory (RAM) 103, a storage 104, an input unit 105, a display 106, a document reader 107, an image forming unit 108, a communication unit 109, and an IC card reader 110. These units are communicably connected to each other via a bus 111.

The CPU 101 executes various programs and controls each unit. That is, the CPU 101 reads a program from the ROM 102 or the storage 104, and executes the program using the RAM 103 as a work area. The CPU 101 controls each of the units described above and performs various arithmetic processing according to the program recorded in the ROM 102 or the storage 104. In the present exemplary embodiment, the program is stored in the ROM 102 or the storage 104.

The ROM 102 stores various programs and various data. The RAM 103 temporarily stores a program or data as the work area. The storage 104 includes a hard disk drive (HDD) or a solid state drive (SSD). The storage 104 stores various programs including an operating system and various data.

The storage 104 stores a password that has been set for print data (for example, portable document format (PDF) file) included in a print job and is required for a user to print the print data. As will be described later, in printing a PDF file for which a password required for printing has been set, the CPU 101 allows printing of the PDF file in response to input of such a stored password. Accordingly, the user can print the PDF file without unlock the password in advance or inputting the password.

The input unit 105 includes a pointing device such as a mouse, and a keyboard. The user uses the input unit 105 to make various inputs. The user uses the input unit 105 to execute a function, for example, to input an instruction to start printing, as will be described later. In the present exemplary embodiment, a touch panel display 106 serves as the input unit 105.

The display 106 is, for example, a liquid crystal display. The display 106 displays various information under control of the CPU 101. The display 106 adopts a touch panel and also serves as the input unit 105.

The document reader 107 transports documents placed on a sheet feed table of an automatic document feeder (not shown) provided at an upper part of the image forming apparatus 30 one by one, and optically reads the transported documents to acquire image information. Alternatively, the document reader 107 optically reads a document placed on a table such as platen glass to acquire image information.

Here, the image information of the documents read by the document reader 107 is stored in the storage 104 of the image forming apparatus 30, printed by the image forming unit 108 to be described later, or transmitted to another image forming apparatus having a facsimile (FAX) function by the communication unit 109 to be described later.

The image forming unit 108 forms, that is, prints an image on a recording medium such as a sheet of paper, based on (i) print data included in a print job acquired from the PC 50 connected via the network N or (ii) the image information acquired by the reading operation of the document reader 107.

The communication unit 109 is connected to the network N. The communication unit 109 of the image forming apparatus 30 communicates with other apparatuses such as the other image forming apparatuses 20 and 40 and the PC 50.

The communication unit 109 connects the image forming apparatus 30 to a public line, and transmits and receives the image information acquired by the reading operation of the document reader 107 to and from another image forming apparatus having the FAX function.

The IC card reader 110 is a device that reads information stored in an integrated circuit (IC) card, for example, a user ID. The IC card reader 110 reads the information stored in the IC card, identifies the user, and then allows execution of the function of the image forming apparatus 30.

The exemplary embodiment presumes that IC cards in each of which a respective one of user IDs or the like is stored as user information are distributed to users of the image forming apparatus 30.

The present disclosure is not limited to a case where a user is specified by reading the IC card using the IC card reader 110. Alternatively, a user may input his/her user ID using the input unit 105 without using the IC card reader 110, so that the user who is using the image forming apparatus 30 is specified. Further alternatively, the user information may be registered in the image forming apparatus 30 in advance, a list of the registered user information may be read and displayed on the display 106, a user may select his/her user information from among the user information displayed on the display 106, so that the user is specified.

Next, an operation of the image forming system 10 will be described.

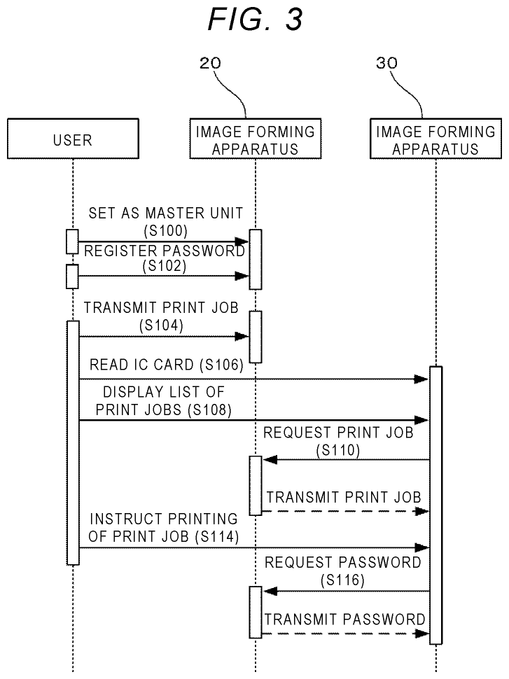

FIG. 3 is a sequence diagram showing an example of the operation of the image forming system 10.

In step S100 shown in FIG. 3, the user accesses the image forming apparatus 20 to be set as the master unit using the PC 50 connected to the network N. Then, the user sets the image forming apparatus 20 as the master unit. The CPU 101 of the image forming apparatus 20 that has received a setting of the master unit stores master unit setting information.

Here, the present disclosure is not limited to a case in which the master unit is set using the PC 50 connected to the network N. Alternatively, the master unit may be set using the input unit 105 of the image forming apparatus 20, which is the master unit, or the input unit 105 of the image forming apparatuses 30 or 40 which is the slave unit. In the present exemplary embodiment, although the image forming apparatuses 30 and 40 are not explicitly set as the slave master units, the image forming apparatuses 30 and 40 other than the master unit serve as the slave units. It is noted that the present disclosure is not limited thereto. The user may access the image forming apparatuses 30 and 40 to set the image forming apparatuses 30 and 40 as the slave units.

In step S102, the user accesses the image forming apparatus 20, which has been set as the master unit, using the PC 50 connected to the network N. Then, the user registers a password for printing a print job in the image forming apparatus 20. The CPU 101 of the image forming apparatus 20 that has received such a setting of the password stores the password. Here, the present disclosure is not limited to a case in which the password is registered using the PC 50 connected to the network N. Alternatively, the user may set the password using the input unit 105 of the image forming apparatus 20, which is the master unit, or the input unit 105 of the image forming apparatus 30 or 40, which is the slave unit. Furthermore, the present disclosure is not limited to a case in which the password is set only in the master unit. Alternatively, the password may be set in any of the slave units. The setting of the master unit in step S100 and the registration of the password in step S102 may be performed in a reverse order or simultaneously.

In step S104, the user transmits a print job that he/she wants to print from the PC 50 connected to the network N. In the present exemplary embodiment, as described above, the print job is transmitted to the image forming apparatus 20, which is the master unit. The image forming apparatus 20 that has received the print job stores the print job. The print job includes the user information that identifies the user who uses the PC 50. The CPU 101 of the image forming apparatus 20 can recognize the user who has transmitted the print job.

In step S106, the user causes the IC card reader 110 of the image forming apparatus 30 to read the IC card. Here, the image forming apparatus 30 which the user causes to read the IC card is an image forming apparatus installed at a place to which the user has moved from his/her own seat or the like in order to print a print job. The CPU 101 of the image forming apparatus 30 that has received the IC card performs a process of logging in the image forming apparatus 30.

In step S108, the user operates the image forming apparatus 30 using the input unit 105 of the image forming apparatus 30 so as to display a list of print jobs.

In step S110, the CPU 101 of the image forming apparatus 30 requests the image forming apparatus 20 for print jobs having user information that match the user information registered in the read IC card. In response, the CPU 101 of the image forming apparatus 20 transmits the print jobs. The CPU 101 of the image forming apparatus 30 that has received the print job displays a list of the print jobs on the display 106.

In step S114, the user inputs a print instruction using the input unit 105 of the image forming apparatus 30. For example, the user selects a job to print from the displayed list of the print jobs, and operates a print execution switch.

In step S116, the CPU 101 of the image forming apparatus 30 requests the image forming apparatus 20 for password information. In response, the CPU 101 of the image forming apparatus 20 transmits the password information. Then, when the password set in the print job for which the print instruction has been given matches a password acquired from the image forming apparatus 20, the CPU 101 of the image forming apparatus 30 executes printing of the print j ob.

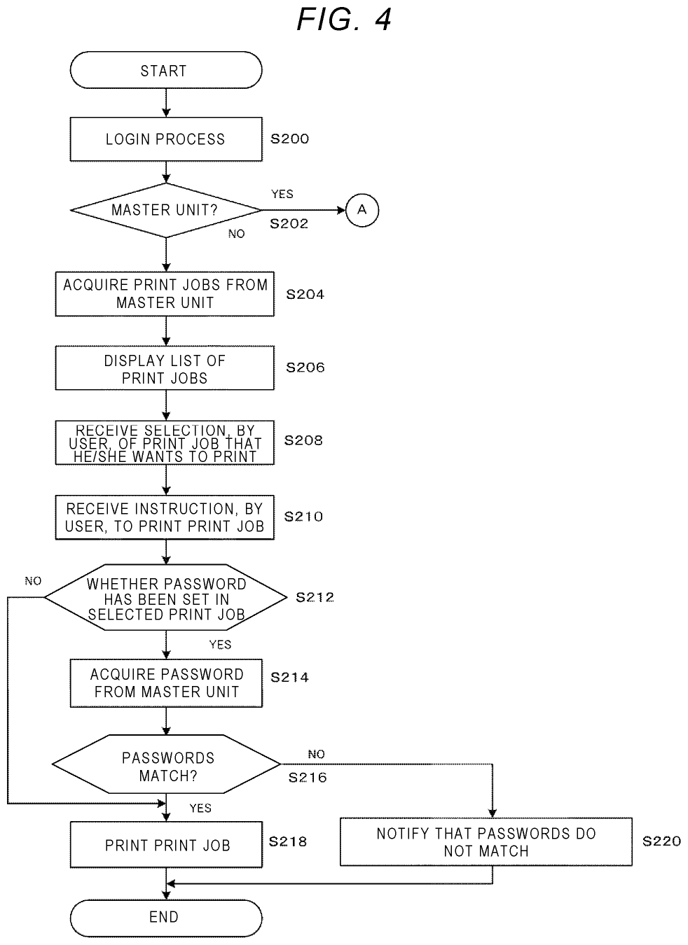

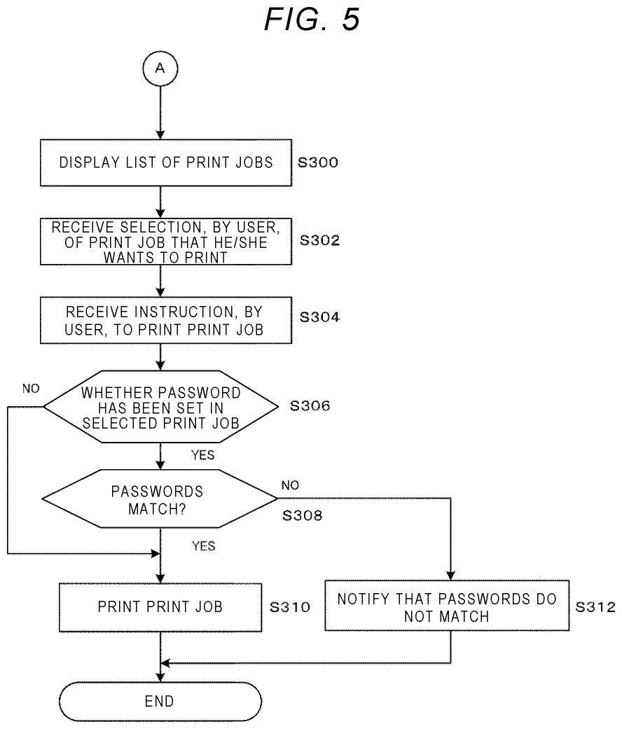

Next, a flow of processing when the printing of the print job is performed using the image forming apparatuses 20 and 30 will be described with reference to FIGS. 4 and 5.

In step S200 shown in FIG. 4, upon the user causing the IC card reader 110 to read the IC card, the CPU 101 of the image forming apparatus 30 performs the login process for the user. Then, the flowchart proceeds to the next step S202.

In step S202, the CPU 101 of the image forming apparatus 30 determines whether the image forming apparatus 30 has been set as a master unit by the user. If it is not determined that the image forming apparatus 30 has been set as a master unit, that is, it is determined that the image forming apparatus 30 has been set as a slave unit, the flowchart proceeds to the next step S204.

In step S204, when the user selects the printing function from among the functions of the image forming apparatus 30, the CPU 101 of the image forming apparatus 30 (which is the slave unit) acquires, from the master unit, print jobs having user information that match the user information registered in the read IC card. Then, the flowchart proceeds to the next step S206.

In step S206, the CPU 101 of the image forming apparatus 30 receives an instruction input by the user using the input unit 105 to display a list of print jobs on the display 106 and displays a list of the print jobs acquired in step S204 on the display 106. Here, the instruction input by the user using the input unit 105 to display the list of the print jobs on the display 106 corresponds to the user selecting the printing function from among the functions of the image forming apparatuses 20 and 30. That is, in response to the user selecting the printing function on the image forming apparatus 30 installed on the place to which the user has moved, the list of the print jobs is displayed. Then, the flowchart proceeds to the next step S208.

In step S208, the CPU 101 of the image forming apparatus 30 receives a selection, by the user, of a print job that he/she wants to print. Specifically, the user selects a print job that he/she wants to print using the input unit 105 from the list of the print jobs displayed on the display 106. The CPU 101 of the image forming apparatus 30 receives a selection result. Then, the flowchart proceeds to the next step S210.

In step S210, the CPU 101 of the image forming apparatus 30 receives an instruction, by the user, to print the print job. Specifically, the CPU 101 of the image forming apparatus 30 receives a switch operation to execute printing. The switch operation is performed by the user after the user selects the print job in step S208. Then, the flowchart proceeds to the next step S212.

In step S212, the CPU 101 of the image forming apparatus 30 determines whether a password for outputting the print job has been set in the selected print job. If it is determined that the password has been set, the flowchart proceeds to the next step S214. If it is not determined that the password has been set, that is, if the password has not been set, the flowchart proceeds to step S218 to be described later.

In step S214, the CPU 101 of the image forming apparatus 30 acquires a password from the image forming apparatus 20, which is the master unit. Then, the flowchart proceeds to the next step S216.

In step S216, the CPU 101 of the image forming apparatus 30 collates the password, which has been registered in the master unit and has been acquired in step S214, and the password set in the print job for which the print instruction has been received in step S210, to determine whether there exists a match. If it is determined that the passwords match based on a collation result, the flowchart proceeds to the next step S218.

In step S218, the CPU 101 of the image forming apparatus 30 changes an attribute of the print job to “permitted to print”, and performs the printing of the print job, that is, outputs the print job on a sheet. Then, the process ends.

On the other hand, if it is not determined in step S216 that the passwords match, that is, if the passwords are different, the flowchart proceeds to step S220.

In step S220, the CPU 101 of the image forming apparatus 30 notifies that the passwords do not match. Such notification is performed, for example, by displaying a message such as “passwords are different” on the display 106. Then, the process ends. When it is notified that the passwords do not match, the process may not be ended, but input of a password may be received, the received password may be collated with the password set in the print job, and the printing may be performed.

If it is determined in step S202 described above that the image forming apparatus 30 is the master unit, the flowchart proceeds to step S300 shown in FIG. 5.

In step S300, when the user selects the printing function from among the functions of the image forming apparatus 20, the CPU 101 of the image forming apparatus 20 displays a list of print jobs transmitted from the PC 50 on the display 106. Then, the flowchart proceeds to the next step S302.

In step S302, the CPU 101 of the image forming apparatus 20 receives a selection, by the user, of a print job that he/she wants to print. Specifically, the user selects a print job that he/she wants to print using the input unit 105 from the list of the print jobs displayed on the display 106. The CPU 101 of the image forming apparatus 20 receives a selection result. Then, the flowchart proceeds to the next step S304.

In step S304, the CPU 101 of the image forming apparatus 20 receives an instruction, by the user, to print the print job. Specifically, the CPU 101 of the image forming apparatus 20 receives a switch operation to execute printing. The switch operation is performed by the user after the user selects the print job in step S302. Then, the flowchart proceeds to the next step S306.

In step S306, the CPU 101 of the image forming apparatus 20 determines whether a password for outputting the print job has been set in the selected print job. If it is determined that the password has been set, the flowchart proceeds to the next step S308. If it is not determined that the password has been set, that is, if the password has not been set, the flowchart proceeds to step S310 to be described later.

In step S308, the CPU 101 of the image forming apparatus 20 collates the password stored in the storage 104 and the password set in the print job for which the print instruction has been received in step S304 to determine whether there exists a match. If it is determined that the passwords match based on the collation result, the flowchart proceeds to the next step S310.

In step S310, the CPU 101 of the image forming apparatus 20 changes an attribute of the print job to “permitted to print”, and performs the printing of the print job, that is, outputs the print job on a sheet. Then, the process ends.

On the other hand, if it is not determined in step S308 that the passwords match, that is, if the passwords are different, the flowchart proceeds to step S312.

In step S312, the CPU 101 of the image forming apparatus 20 notifies that the passwords do not match. Such notification is performed, for example, by displaying a message such as “passwords are different” on the display 106. Then, the process ends. When it is notified that the passwords do not match, the process may not be ended, but input of a password may be received, the received password may be collated with the password set in the print job, and the printing may be performed.

### Modifications

The present disclosure is not limited to the above-described exemplary embodiment. Various modifications and changes may be made without departing from the gist of the present disclosure.

In the above-described exemplary embodiment, the password registered in the master unit and the password set in the print job match are collated to determine whether there exists a match when the print instruction input by the user using the input unit is received after the print job is received (see step S216 in FIG. 4 and step S308 in FIG. 5). The passwords may be collated at another timing.

### First Modification

For example, passwords may be collated when an instruction input by the user using the input unit 105 to display a list of print jobs on a display is received after the print job is received. The passwords may be collated at a timing between step S204 and step S206 of FIG. 4 or between step S202 of FIG. 4 and step S300 of FIG. 5. Here, the instruction input by the user using the input unit 105 to display the list of the print jobs on the display 106 corresponds to the user selecting the printing function from among the functions of the image forming apparatuses 20 and 30. That is, when the user selects the printing function on the image forming apparatus 20 or 30 installed at the place to which the user has moved, the passwords are collated. Then, when the passwords match, the user selects a print job from the displayed list of the print jobs (see step S208 in FIG. 4 and step S302 in FIG. 5), and inputs the print instruction (see step S210 in FIG. 4 and step S304 in FIG. 5). When the passwords do not match, the user is notified that the passwords do not match (see step S220 in FIG. 4 and step S312 in FIG. 5).

In this modification, the list of the print jobs and a result of collating the passwords for each print job may be displayed on the display 106. With this configuration, the user can recognize the result of collating the passwords before instructing the printing.

### Second Modification

For example, passwords may be collated upon the image forming apparatus 20, which is the master unit, receiving the print job. This timing is in step 5104 of FIG. 3. With this configuration, since the master unit collates the passwords, a burden on the slave unit to collate the passwords can be reduced.

In this modification, the result of collating the passwords for the transmitted print job may be displayed on a display of the PC 50. With this configuration, the user can recognize the result of collating the passwords before moving to the image forming apparatus 20, 30, or 40 for printing. When an instruction input by the user using the input unit 105 to display the list of print jobs on the display is received, the display 106 may display the list of the print jobs and the result of collating the password for each print job. With this configuration, the user can recognize the result of collating the passwords before instructing the printing.

### Others

The present disclosure is not limited to the case where the password is registered in the image forming apparatus 20, which is the master unit. Alternatively, the password may be registered in any of the slave units.

In this case, when printing is to be performed on the slave unit, first, the password registered in the slave unit and the password set in the print job are collated. If the passwords do not match, the password is acquired from the master unit and collated. With this configuration, different passwords can be registered on the master unit and the slave units.

A technique disclosed above may also be applied to apparatuses other than the image forming apparatus, for example, information processing apparatuses such as a smartphone and a tablet. That is, the present disclosure can be regarded as a disclosure that enables a file to be transmitted from a first apparatus of at least two apparatuses for each of which unique information is set to a second apparatus of the at least two apparatuses and enables, when the unique information set in the first apparatus is required to open a file transmitted from the first apparatus on the second apparatus, the file to be opened on the second apparatus using the unique information set in the first apparatus.

As a specific example, first, a limitation is set for a file such as a document file such that the file can be opened and displayed only by a specific information processing apparatus, for example, the file can be opened and displayed only when apparatus-specific information such as a media access control address (MAC address) of a terminal matches information included in the file. Then, when a specific condition is satisfied between a first smartphone and a second smartphone, for example, it is confirmed that a user of the first smartphone is the same as a user of the second smartphone (for example, the user logs in the first and second smartphones with the same account), if a MAC address of the first smartphone matches a MAC address included in a file after the file is transmitted from the first smartphone to the second smartphone by communication such as short range wireless communication, the file is allowed to be opened on the second smartphone.

With this configuration, even when the first smartphone receives a file, but the file is to be opened on the second smartphone or another tablet, there is no need to transmit the file to the second smartphone or reset the limitation such that the file can be opened on the second smartphone. Of course, the apparatus-specific information is not limited to unique information that is determined in advance for the apparatus such as the MAC address of the terminal. The apparatus specific information may be a password set by the user for each apparatus, an Internet Protocol address (IP address) determined by a server other than the apparatus, or a value calculated based on the MAC address and the IP address. With regard to confirmation of the same user, the modification is not limited to a case in which the user logs in the apparatuses with the same account. Alternatively, it may be determined that the users on the apparatuses are the same user based on (i) a fact that a method (for example, a short range wireless communication) is employed that can communicate only when the user intentionally perform an action or (ii) a fact that only the same user can perform an operation satisfying a condition, for example, a fact that the user directs the apparatuses to specific directions in communicating a file or a fact that the user performs a specific operation on a second apparatus while a first apparatus is in a standby state. Further, it is not necessary to confirm if the users are the same user. For example, when a file has been transmitted, an apparatus that has received the file may be allowed to open the file regardless of whether the users are the same user.

The above exemplary embodiment has described a case in which a program is stored (installed) in the ROM 102 or the storage unit (storage) 104 in advance. It is noted that the present disclosure is not limited thereto. The program may be provided in a form recorded in a recording medium such as a compact disk read only memory (CD-ROM), a digital versatile disk read only memory (DVD-ROM), and a universal serial bus (USB) memory. The program may be downloaded from an external apparatus via a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

what is claimed is:

1. An image forming apparatus comprising:
a processor configured to:
acquire a password registered in an image forming apparatus of a plurality of image forming apparatuses connected to a network; and
when a password that has been set in a print job and is required to output the print job matches the registered password, allow outputting of the print job.

2. The image forming apparatus according to claim 1, wherein
the processor is configured to:
upon receipt of a print instruction input by a user using an input unit after receiving the print job, collate the password set in the print job and the registered password to determine whether a match exists.

3. The image forming apparatus according to claim 1, wherein
the print job comprises a plurality of print jobs, and
the processor is configured to:
upon receipt of an instruction input by a user using an input unit to display a list of the print jobs on a display after receiving the print jobs, collate the passwords set in the print jobs and the registered password to determine whether a match exists.

4. The image forming apparatus according to claim 3, wherein
the processor is configured to:
display the list of the print jobs and a collation result for each print job, on the display.

5. The image forming apparatus according to claim 1, wherein
the processor is configured to:
when the password set in the print job and the registered password do not match, notify that the passwords do not match.

6. The image forming apparatus according to claim 2, wherein
the processor is configured to:
when the password set in the print job and the registered password do not match, notify that the passwords do not match.

7. The image forming apparatus according to claim 3, wherein
the processor is configured to:
when the passwords set in the print jobs and the registered password do not match, notify that the passwords do not match.

8. The image forming apparatus according to claim 4, wherein
the processor is configured to:
when the passwords set in the print jobs and the registered password do not match, notify that the passwords do not match.

9. A non-transitory computer readable medium storing a program that causes a computer to execute information processing, the information processing comprising:
acquiring a password registered in an image forming apparatus of a plurality of image forming apparatuses connected to a network; and
when a password that has been set in a print job and is required to output the print job matches the registered password, allowing outputting of the print job.

10. The non-transitory computer readable medium according to claim 9, wherein
the information processing further comprises:
upon receipt of a print instruction input by a user using an input unit after receiving the print job, collating the password set in the print job and the registered password to determine whether a match exists.

11. The non-transitory computer readable medium according to claim 9, wherein
the print job comprises a plurality of print jobs, and
the information processing comprises:
upon receipt of an instruction input by a user using an input unit to display a list of the print jobs on a display after receiving the print jobs, collating the passwords set in the print jobs and the registered password to determine whether a match exists.

12. The non-transitory computer readable medium according to claim 11, wherein
the information processing further comprises:
displaying the list of the print jobs and a collation result for each print job, on the display.

13. The non-transitory computer readable medium according to claim 9, wherein
the information processing comprises:
when the password set in the print job and the registered password do not match, notifying that the passwords do not match.

14. The non-transitory computer readable medium according to claim 10, wherein
the information processing comprises:
when the password set in the print job and the registered password do not match, notifying that the passwords do not match.

15. The non-transitory computer readable medium according to claim 11, wherein
the information processing comprises:
when the passwords set in the print jobs and the registered password do not match, notifying that the passwords do not match.

16. The non-transitory computer readable medium according to claim 12, wherein
the information processing comprises:
when the passwords set in the print jobs and the registered password do not match, notifying that the passwords do not match.

17. An image forming method comprising:
acquiring a password registered in an image forming apparatus of a plurality of image forming apparatuses connected to a network; and
when a password that has been set in a print job and is required to output the print job matches the registered password, allowing outputting of the print job.
